(19) United States
(12) Patent Application Publication
(10) Pub. No.: US 2011/0174006 A1
(43) Pub. Date: Jul. 21, 2011

(54) ZONE TEMPERATURE CONTROL ON BOARD AN AIRPLANE BY MEANS OF FUEL CELL WASTE HEAT

(75) Inventors: Martin Arendt, Meine (DE); Till Marquardt, Hamburg (DE); Andreas Westenberger, Buxtehude (DE); Lars Frahm, Halstenbeck (DE)

(73) Assignee: AIRBUS OPERATIONS GMBH, Hamburg (DE)

(21) Appl. No.: 13/060,829

(22) PCT Filed: Aug. 12, 2009
(86) PCT No.: PCT/EP09/60447

§ 371 Date: Apr. 4, 2011

(30) Foreign Application Priority Data
Aug. 26, 2008 (DE) 10 2008 039 782.2

(51) Int. Cl. F25B 27/00; B64D 13/06; B64D 13/02

(52) U.S. Cl. 62/238.1; 454/74; 165/203

(57) ABSTRACT

The invention relates to an air conditioning system for a transportation means, having multiple zones to be air-conditioned, which may be variably air-conditioned by means of processed supply air in combination with individual trim air conduits, wherein the air conditioning system further has at least one heat exchanger for heating supply air by means of the exhaust heat of a fuel cell, and for discharging the supply air into a trim air distributor supplying the trim air conduits.

### REFERENCE TO RELATED APPLICATIONS

This application claims the benefit of the filing date of U.S. Provisional Application No. 61/190,082, filed Aug. 26, 2008 and of German Patent Application No. 10 2008 039 782.2 filed Aug. 26, 2008, the disclosure of which applications is hereby incorporated herein by reference.

### TECHNICAL FIELD

The invention relates to environmental control system for a means of transport, to a method for differentiated air conditioning of zones in a cabin of a means of transport, to the use of an environmental control system in a means of transport, and to an aircraft comprising at least one such environmental control system.

### BACKGROUND OF THE INVENTION

For individual temperature control, cabins of means of transport are frequently divided into several zones, with each zone preferably comprising its own air supply line that conveys air with individually predetermined parameters, for example temperature, into the respective zone. For example, modern commercial aircraft frequently comprise environmental control systems that condition the air in the aircraft cabin differently in several zones. However, air conditioning takes place in such a manner that air that has been conditioned by a single central device is provided at a determined temperature. Since by means of this air all the zones within the cabin of the commercial aircraft are to be individually air conditioned it is necessary for the air to comprise the lowest temperature requested by the zones, because in the different zones there are no possibilities for subsequent cooling. However, this results in zones with a requirement for higher temperatures having to make use of additional heating of the supply air. Normally, this additional heat is provided in the form of hot bleed air from the engines, which bleed air is fed into the air stream from the environmental control system. As an alternative to this, decentralised electrical heating devices are also installed, which are used for heating the supply air.

### SUMMARY OF THE INVENTION

In the example of a commercial aircraft it is disadvantageous to subsequently, with the associated expenditure of energy, reheat air that has already been cooled and conditioned by an environmental control system. At present, environmental control systems are in wide use that are exclusively or to a very large part operated by means of bleed air from the engines, so that further, subsequent, removal of bleed air for heating the air that has been cooled with considerable expenditure results in a relatively unfavourable energy balance. Since, furthermore, electrical heating devices that are used in addition or as an alternative to the above are also associated with a considerable current consumption, which also results in additional fuel consumption, an environmental control system as described above does not present an optimum solution.

It is the object of the invention to propose an environmental control system in which multiple-zone air conditioning is made possible with the smallest possible additional fuel consumption. In particular, it is the object of the invention to propose an environmental control system in which neither additional removal of hot bleed air nor electrical heating alone is required for providing multiple-zone air conditioning.

This object is met by an environmental control system for a means of transport with the above-mentioned characteristics, wherein the environmental control system further comprises at least one heat exchanger with a first and a second inlet as well as a first outlet, wherein the first inlet is connected to a supply air line, the second inlet is connected to an exhaust gas line of a fuel cell, and the first outlet is connected to the trim-air distributor and is designed, from the heat of the exhaust gas of the fuel cell, to heat the supply air flowing into the trim-air distributor. Such an environmental control system is advantageous as a result of the fact that the exhaust heat of a fuel cell, which is frequently found in modern commercial aircraft or which has been incorporated in the concept of such a modern commercial aircraft, can be utilised in a sensible manner instead of said exhaust air simply being released to the surroundings. The hot air led away in the trim-air lines is in a position to individually heat the zones by individual setting of the trim-air valves, wherein no additional electrical heating or additional removal of bleed air is required. This considerably improves the effectiveness of the energy supply in the aircraft, because a fuel cell can be cooled and at the same time the heat resulting from this is used, without additional expenditure of energy, for heating supply air fed into the individual cabin zones.

In a particularly preferred manner the supply air line on the first inlet of the fuel cell is supplied with air from the cabin. This is particularly advantageous because this air is already “used” and usually some of it, for example 40%, is returned to the cabin where it continues to be used. This returned (recirculated) air can then at least in part be heated by the heat exchanger and can be fed back to the cabin by way of the trim-air lines. As a result of this the energy consumption is further reduced as is the fuel consumption.

Furthermore, it is particularly preferred if the fuel cell is a medium-temperature fuel cell. Medium-temperature fuel cells are simpler in design and in operation than low-temperature fuel cells; they are very effective and thus particularly well suited to operation in a means of transport in which limited installation space is available and where only limited transport weight can be realised. Medium-temperature fuel cells have an operating temperature of between 90° C. and approximately 220° C. They are less sensitive to impurities and as a result of their higher operating temperature are easier to cool than is the case with low-temperature fuel cells. For the same reason it can, furthermore, also be advantageous to provide a high-temperature fuel cell that comprises an operating temperature of more than 220° C.

On the other hand it can, however, also be advantageous if the fuel cell is a low-temperature fuel cell whose operation, while in regard to purity of the fuels and the output achieved may not be optimal, nevertheless may also be considered for operation in a means of transport due to the low temperatures to be expected. However, with the use of a low-temperature fuel cell a greater air volume flow through the heat exchanger must be provided to implement an adequate increase in air temperature in the zone-air lines. The operating temperature of low-temperature fuel cells ranges between 60° C. and 90° C.

In an advantageous improvement of the environmental control system according to the invention, in the zone-air lines sensors are arranged for determining the air volume flow. This makes it possible to determine the air volume flows required in the individual zones, to which air volume flows the trim-air volume flows can be attuned to reach a predetermined end temperature in the individual zones.

Consequently it is also advantageous if an environmental control system according to the invention furthermore comprises at least one control device which is connected to the sensors and the trim air valves. In this way the air volume flow in the zone-air lines can be determined and at the same time the trim-air flows can be matched to the aforesaid by way of the trim-air valves.

Furthermore, it is advantageous if the environmental control system according to the invention comprises at least one additional heating device for heating the air conveyed in the trim-air lines and/or in the zone-air lines. In those cases where a fuel cell that is integrated in a means of transport is merely used as an emergency supply device for supply at a base or in commercial aircraft on the ground, in particular driving phases or flight phases corresponding fuel cell exhaust heat may be entirely absent. In these phases such an operating phase could be bridged by means of an additional heating device, wherein in the overall balance the energy consumption is considerably more advantageous than it is in the state of the art, where generally-speaking an increase in the air temperature is achieved by means of additional heating or the like.

The object is further met by a method for individually air conditioning zones in a cabin of a means of transport. Furthermore, the object is met by the use of an environmental control system with the above-mentioned characteristics in a means of transport, as well as by an aircraft comprising at least one fuel cell and at least one environmental control system with the characteristics mentioned above.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or their interrelationships. Furthermore, identical or similar objects in the figures have the same reference characters. The following are shown:

FIG. 1: a diagrammatic view of an environmental control system according to the state of the art;

FIG. 2: a diagrammatic view of an environmental control system according to the invention; and

FIG. 3: a diagrammatic view of a method according to the invention.

### DETAILED DESCRIPTION OF EXEMPLARY EMBODIMENTS

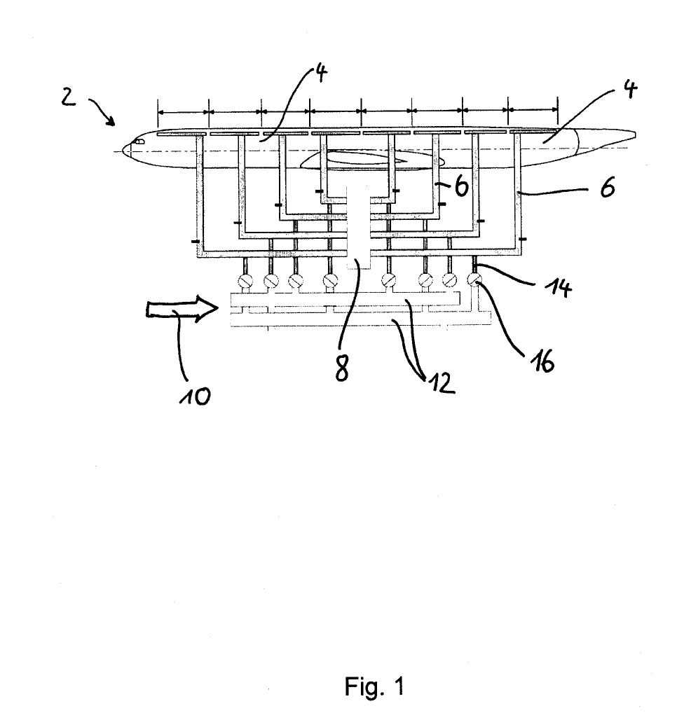

FIG. 1 shows an aircraft 2 according to the state of the art, which aircraft 2 comprises 8 different zones 4 that can be air conditioned in a different manner. Air is channelled into the individual zones 4 by way of zone-air lines 6 which are supplied with air by way of a mixing chamber or mixing unit 8. In the mixing unit 8, correspondingly conditioned fresh air is mixed with used cabin air from the individual zones 4 and is used for further air conditioning of the zones 4. To make it possible for the individual zones 4 to be individually air conditioned, it is necessary to set the air that is being provided by way of the mixing unit 8 in such a manner that it has the lowest temperature requested by the different zones 4. This could, for example, be 18° C. In order to increase this air temperature, relatively warm bleed air 10 is used, which by means of one or several trim-air distributors 12 is distributed to several trim-air lines 14 in each case by way of a trim-air valve 16. The trim-air lines 14 are connected to the zone-air lines 6 and are equipped to mix warm bleed air 10 in the respective volume flow of an associated zone-air line 6 so that the temperature of the air arriving in the individual zones 4 has increased to the desired extent. The control of the temperature in the individual zones 4 takes place by way of the trim valves 16 which can, for example, be designed as control valves that can be controlled by way of a control unit (not shown) or the like.

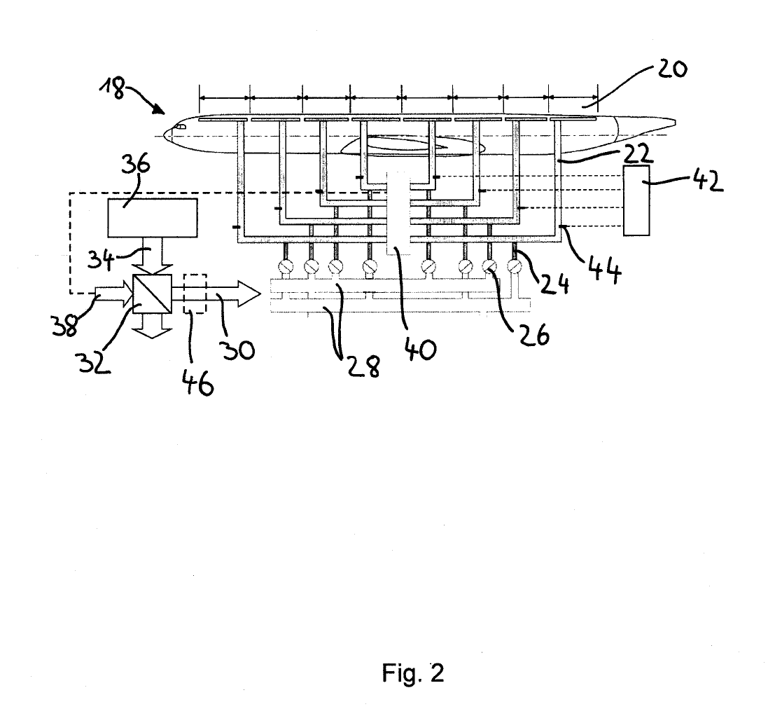

This environmental control system according to the state of the art is associated with a disadvantage in that already cooled air from the mixing unit 8 needs to be brought back to a higher temperature level by means of bleed air 10 removed from the engines. Consequently, energy is used both during cooling and during subsequent reheating, a deficiency which can be remedied by the environmental control system according to the invention, as will be described in detail below with reference to FIG. 2.

In this arrangement an aircraft 18 also comprises eight different zones 20, which are in each case supplied with air by way of zone-air lines 22. In each case trim-air lines 24 are associated with the zone-air lines 22, which trim-air lines by way of trim-air valves 26 obtain air from one or several trim-air distributors 28. The trim-air distributors 28 are supplied with heated air 30 that originates from a heat exchanger 32 through which exhaust gases 34 of a fuel cell 36 flow. The supply air 38 flowing into the heat exchanger 32 is preferably removed from the cabin which comprises several zones 20, because this air is already “used” and is fed anyway in part to a mixing unit 40 and by way of it back into the zones 20.

Preferably the environmental control system according to the invention comprises a control unit 42 which is connected to flow sensors 44 in the zone-air lines 22. As a result of this the control unit 42 can determine which air volume flows are present in the zone-air lines 22 and can, depending on the desired temperatures in the zones 20, correspondingly set the respective trim valves 26. By setting the trim valves 26 the mixing ratio of the warm air 30 from the heat exchanger 32 to air from the mixing unit 40 is set.

With the use of a medium-temperature fuel cell a lower trim-air volume flow through the heat exchanger 32 is to be set than is the case with the use of a low-temperature fuel cell. This is due to the exhaust gas temperature in a low-temperature fuel cell being significantly lower than that of a medium-temperature fuel cell, which can, for example, attain temperatures of 200° C. or more. A low-temperature fuel cell produces exhaust gases with a temperature of only up to 90° C.

If the fuel cell is not available in some operating phases, an additional heating device 46 could be used for providing heated air 30 for the trim-air lines 24. For example additional electrical heaters of whatever design might be considered.

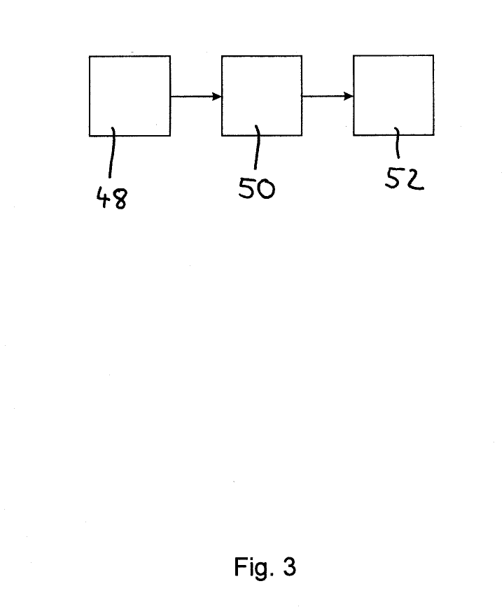

FIG. 3 diagrammatically shows the method for the individual air conditioning of zones in a cabin of a means of transport. In principle, air is delivered 48 by way of the zone-air lines into the zones, supply air is heated 50 by means of the exhaust heat of the fuel cell and is delivered 52 to the zone-air lines as required, by way of trim-air lines and trim valves, in order to increase the temperature in the individual zones.

In summary, the environmental control system according to the invention is in a position to provide multiple-zone air conditioning in a means of transport, which multiple-zone air conditioning from the point of view of energy consumption is particularly advantageous, in which means of transport the additional consumption of energy and/or fuel is significantly reduced or even entirely eliminated.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

### REFERENCE CHARACTERS

2 Aircraft

4 Zone

6 Zone-air line

8 Mixing unit

10 Bleed air

12 Bleed air distributor

14 Trim-air line

16 Trim valve

18 Aircraft

20 Zone

22 Zone-air line

24 Trim-air line

26 Trim valve

28 Trim-air distributor

30 First outlet fuel cell/heated air

32 Heat exchanger

34 Exhaust gas (line) fuel cell

36 Fuel cell

38 Supply air (line)

40 Mixing unit

42 Control unit

44 (Volume-flow) sensor

46 Heating device

48 Delivering air to the zones

50 Heating supply air by means of exhaust heat from the fuel cell

52 Optional delivery of trim air

1. An environmental control system for a means of transport, wherein the means of transport has at least one cabin comprising one or several zones to be air conditioned, the environmental control system comprising:
one or more zone-air lines for delivering conditioned air to the zones;
one or more trim-air lines;
one or more trim-air valves;
at least one trim-air distributor, wherein each of the one or more trim-air line is associated with at least one of the one or more zone-air lines, the one or more trim-air lines being adapted to supply heated trim air to the associated one or more zone-air lines via the one or more trim-air valves for increasing air temperature in the one or more zone-air lines, wherein the one or more trim-air lines are connected to at least one air outlet of the at least one trim-air distributor; and
at least one heat exchanger having first and second inlets and an outlet, wherein the first inlet is connected to a supply air line, the second inlet is connected to an exhaust gas line of a fuel cell, and the outlet is connected to the at least one trim-air distributor, the at least one heat exchanger being adapted to transfer heat of an exhaust gas of the fuel cell to the supply air stemming from the first inlet and flowing into the at least one trim-air distributor via the outlet.

2. The environmental control system of claim 1, wherein the supply air line on the first inlet of the fuel cell is supplied with air from the at least one cabin.

3. The environmental control system of claim 1, wherein the fuel cell is a medium-temperature fuel cell.

4. The environmental control system of one of claim 1, wherein the fuel cell is a low-temperature fuel cell.

5. The environmental control system of one of claim 1, wherein the fuel cell is a high-temperature fuel cell.

6. The environmental control system of claim 1, further comprising zone-air lines sensors are arranged in the one or more zone-air lines for determining air volume flow.

7. The environmental control system of claim 6, further comprising at least one control device is connected to the sensors and to the one or more trim-air valves.

8. The environmental control system of claim 1, further comprising at least one heating device for heating the air in at least one of the one or more trim-air lines or the one or more zone-air lines.

9. A method for individually air conditioning zones in a cabin of a means of transport, the method comprising:
delivering air into the zones through one or more zone-air lines, wherein in each of one or more trim-air lines is associated with at least one of the one or more zone-air lines;
delivering heated trim air from the one or more trim-air lines to the one or more zone-air lines via one or more trim air valves for increasing air temperature in the one or more zone-air lines, wherein the one or more trim-air lines are connected to at least one air outlet of a trim-air distributor;
supplying exhaust gas of a fuel cell to a heat exchanger via a second inlet to heat supply air that flows into the trim-air distributor from an inlet and through an outlet when required by the respective zone.

10-11. (canceled)

12. An aircraft comprising at least one fuel cell and at least one environmental control system of claim 1.
